(19) United States
(12) Patent Application Publication
(10) Pub. No.: US 2011/0081198 A1
(43) Pub. Date: Apr. 7, 2011

(54) FASTENER, SYSTEM AND METHOD FOR CONNECTING ELONGATED MEMBERS

(75) Inventors: John Scott Tihansky, Breinigsville, PA (US); Barry Moyer, Kutztown, PA (US)

(73) Assignee: TimberStrong, LLC, Breinigsville, PA (US)

(21) Appl. No.: 12/851,158

(22) Filed: Aug. 5, 2010

Related U.S. Application Data
(60) Provisional application No. 61/231,537, filed on Aug. 5, 2009.

(51) Int. Cl. F16D 1/00; B23P 11/00

(52) U.S. Cl. 403/376; 29/525.01

(57) ABSTRACT

A fastener for fixedly connecting two members in spaced relation to one another includes a substantially cylindrical shaft having two opposed ends and a central collar portion positioned between the ends. At least one outwardly extending cylindrical ridge is positioned adjacent the central collar portion on either side thereof. Each end of the shaft is inserted longitudinally into apertures defined in the members. The at least one ridge assists in retaining the respective shaft in a respective aperture. A connecting system and a method for connecting two elongated members with the fasteners is also provided.

### CROSS-REFERENCE TO RELATED APPLICATION

This application claims the benefit of U.S. Provisional Application No. 61/231,537, filed Aug. 5, 2009, the disclosure of which is incorporated herein by reference in its entirety.

### BACKGROUND OF THE INVENTION

The installation of decking for such structures as decks and docks is time consuming. It is desirable to provide a fastener and system for improving the efficiency of decking installation. It is also desirable to improve the efficiency of other installations that involve the side-by-side installation of boards or the like.

Nail holes in boards can result in splitters, dimpling, or puckering. Nail and screw pops are also common. It is desirable to fasten together boards in a decking or other system without having to nail or screw through the faces of the boards in order to connect them to an underlying support structure. It is also desirable to provide a mechanism for evenly spacing boards. It is further desirable to be able to prefabricate a panel structure so that it can be transported and installed as a single panel that includes multiple boards.

### SUMMARY OF THE INVENTION

In accordance with the teachings described herein, an example fastener for fixedly connecting two members in spaced relation to one another comprises a substantially cylindrical shaft having two opposed ends and a central collar portion. At least one outwardly extending cylindrical ridge is positioned adjacent the central collar portion on either side thereof. Each end of the shaft is configured to be inserted longitudinally into apertures defined in the members. The at least one ridge assists in retaining the respective shaft in the respective aperture.

In another example, a connecting system comprises at least two elongated members having opposing apertures and at least one fastener positioned between the at least two elongated members for fixedly coupling the elongated members together in spaced relation via the opposing apertures. The fastener has a substantially cylindrical shaft with two opposed ends and a central collar portion. At least one outwardly extending cylindrical ridge is positioned adjacent the central collar portion on either side thereof. The at least one ridge assists in retaining the respective shaft in the respective aperture.

In another example, a method of fixedly connecting two or more elongated members together comprises providing a first elongated member and a second elongated member, with each elongated member having an aperture disposed in opposing sides thereof. The method further comprises inserting one end of a fastener into the aperture in the first elongated member. The fastener has a substantially cylindrical shaft with two opposed ends and a central collar portion, with at least one outwardly extending, cylindrical ridge positioned adjacent the central collar portion on either side thereof. When the shaft is inserted longitudinally into the aperture, the at least one ridge assists in retaining the shaft in the aperture. The method further comprises hammering the fastener into the aperture until the central collar portion abuts the side of the first elongated member. Then the other end of the fastener is inserted into the aperture disposed in the side of the second elongated member. The other end of the fastener is then hammered into the second elongated member until the central collar portion abuts the side of the second elongated member.

### BRIEF DESCRIPTION OF THE DRAWINGS

The present invention will hereinafter be described in conjunction with the appended drawing figures wherein like numerals denote like elements.

FIG. 1 is a top view of an example fastener;

FIG. 2 is an end view of the example fastener of FIG. 1;

FIG. 3 is a cross-sectional view of the example fastener of FIG. 1, taken along line 3-3;

FIG. 4 is a cross-sectional view of a central portion of the example fastener of FIG. 1, taken along line 4-4;

FIG. 5 is a perspective view of an example connecting system with a cut-away of the interior of two hollow-core boards with the example fastener of FIG. 1 installed in apertures defined in the sides of the boards;

FIG. 6 is a cross-sectional view of the example connecting system of FIG. 5, taken along line 6-6;

FIG. 7 is another example fastener;

FIG. 8 is an end view of the fastener shown in FIG. 7;

FIG. 9 is a cross-sectional view of the fastener of FIG. 7 taken along line 9-9;

FIG. 10 is a perspective view of another example connecting system with a cut-away of the interior of two solid-core boards, with the example fastener of FIG. 7 installed in apertures defined on the sides of the boards; and

FIG. 11 is a cross-sectional view of the example connecting system of FIG. 10.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

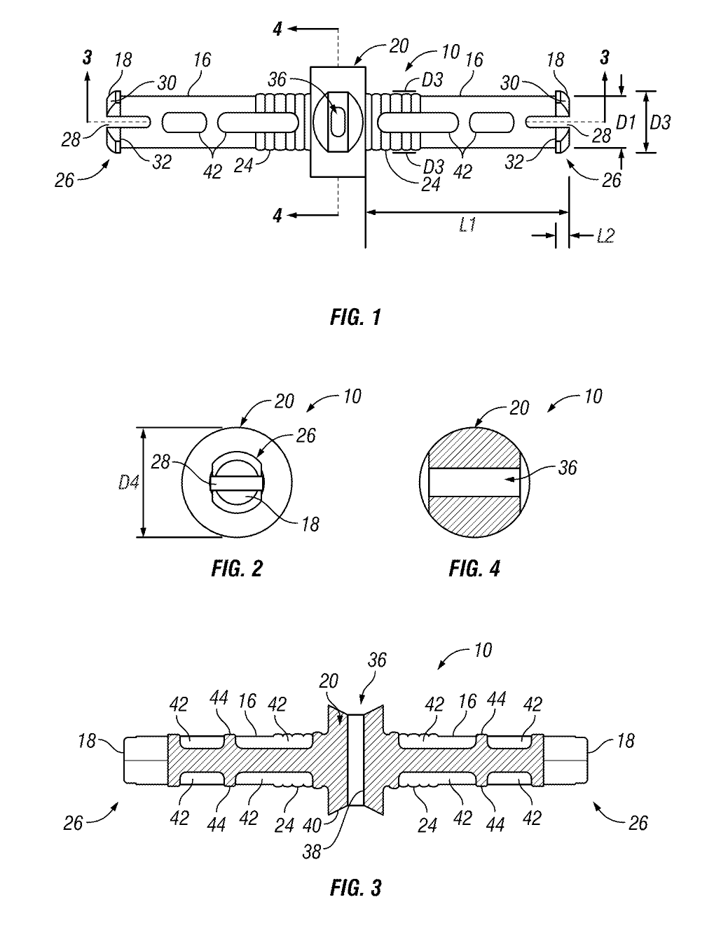

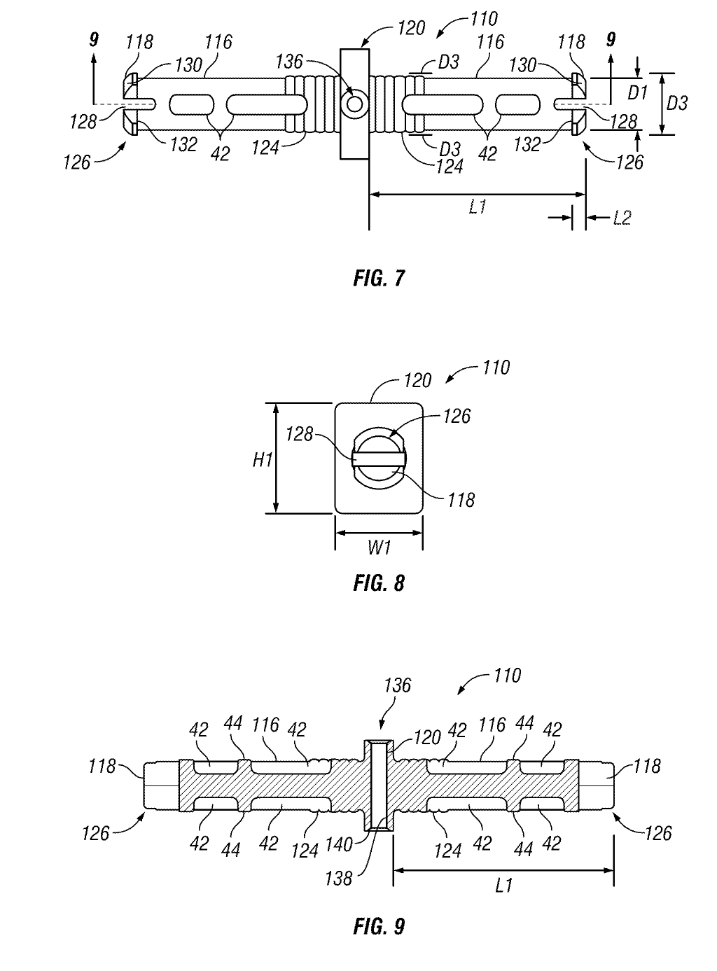

An example fastener 10, 110 is shown in FIGS. 1 and 7. The fastener 10, 110 is used to connect elongated members 12, such as boards, decking, fencing, and the like, to form a rigid panel system. The example fastener 10, 110 is an independent, hidden fastener that may be used to connect different types of elongated members, or to connect similar types of elongated members. The fastener 10, 110 can be used in both residential and commercial applications.

While reference herein is primarily made in the context of decking, such as in connection with decks or docks, it should be understood that these references equally apply in other applications, such as fencing, stair treads, stair landings, animal kennel floors, boardwalks, handicap ramps, gangways, piers, and floating docks, among other applications. The example fastener 10, 110 provides consistent spacing between boards 12. It can be used to connect any species of wood or composite lumber, including both solid and hollow-core composite lumber.

An example connecting system 14, 114 is also described that includes the example fastener 10, 110. The example connecting system 14, 114 provides a rigid connection between elongated members 12, such as boards, decking, fencing materials, and the like, and the underlying supporting structure (not shown). The underlying supporting structure may be joists or other supports. Typically, the joists will be spaced apart from one another. The example fasteners 10, 110 may be connected directly to the supporting joists instead of having to nail or drill through the elongated members 12. The fasteners 10, 110 also provide consistent spacing between adjacent elongated members 12.

A first embodiment of the example fastener 10 and connecting system 14 is shown in FIGS. 1-6. A second embodiment of the example fastener 110 and connecting system 114 is shown in FIGS. 7-11. Elements of the second embodiment that are similar to elements of the first embodiment are represented by reference numerals increased by factors of 100. For example, the fastener 10 in FIGS. 1-6 corresponds to the fastener 110 in FIGS. 7-11.

Referring now to FIG. 1, an example fastener 10 includes a substantially cylindrical shaft 16 having two opposed ends 18. A central collar portion 20 is positioned between the two ends 18. As shown, the portions of the shaft 16 on either side of the central collar portion are substantially the same length. Alternatively, and not shown, the portions of the shaft 16 on either side of the central collar could have different lengths. The shaft 16 has a diameter D1 that is dimensioned to fit snugly inside an aperture or hole 22 having a diameter D2 such that force must be applied to insert the shaft 16 into an aperture 22.

A plurality of outwardly extending cylindrical ridges 24 are positioned adjacent the central collar portion 20 on either side thereof. The ridges 24 extend along part of the length of the shaft 16. The raised ridges 24 have a diameter D3 that is greater than the diameter D1 of the shaft 16. The ridges 24 provide a frictional locking action against the interior of an aperture 22 for assisting in holding the fastener 10 inside an aperture 22. The ridges 24 could extend along more or less of the length of the shaft 16, if desired. The opposed ends 18 of the shaft 16 may be co-linear, as shown.

The ends 18 of the shaft 16 include outwardly flared portions 26, such as outwardly extending tabs. The outwardly flared portions 26 provide a spring-like action for holding the shaft 16 in an aperture 22. A slot 28 is cut into each end 18 of the shaft 16 in the vicinity of the tabs 26 in order to allow the tabs to flex inwardly when inserted into an aperture 22. The slot 28 is shown best in FIGS. 1 and 2. The outwardly flared portions 26 provide a spring-like action against the interior of an aperture 22 once installed. This spring-like action provides locking power for locking the shaft 16 inside an aperture 22. One type of tab that may be utilized has a radiused end 30 for assisting in insertion into an aperture 22. The tab preferably has a lip 32, which may be utilized in some examples for snapping behind an internal rib 34 defined inside a hollow-core board. Other mechanisms for flaring the ends outwardly to create a spring action may also be utilized with equal success, the invention not being limited to the shape of the tabs shown.

The central collar portion 20 has a centrally disposed bore 36 that extends therethrough. The bore 36 may be a cylindrical hole, a tapered hole, or a combination of cylindrical and tapered. A cylindrical bore 38 is shown in FIGS. 3 and 4 that has a tapered opening 40. The bore 36 of the central collar portion 20 preferably faces upwardly during installation. Since the fastener 10 is a mirror image of itself in both the vertical and horizontal directions, the bore 36 can either face upwardly or downwardly with equal success.

Embodiments are also envisioned where the fastener is not a mirror image of itself in either or both of the vertical and horizontal directions. The bore 36 is preferably sized for accepting a second fastener, such as a screw or a nail (not shown) that is used to secure the fastener to a joint.

The central collar portion 20 may be cylindrical, square, or a different cross-sectional shape, and has a height H1 or diameter D4 (depending upon the shape thereof) that is greater than the diameter D1 of the shaft 16. The central collar portion 20 shown in FIG. 2 is cylindrical. The central collar portion 20 also has a width W1 that is utilized to space the elongated members 12 by a fixed spacing that is equal to the width W1 of the collar portion 20.

The collar 20 provides at least two functions. First, it provides a standard spacing between adjacent boards 12. One example of a residential fastener includes a collar 20 having a width of ⅛″, 3/16″, or ¼″ spacing between boards 12. One example of a commercial fastener includes a collar 20 having a width of ⅜″, 7/16″, ½″, 9/16″, or ⅝″ spacing between boards 12. Other sizes may also be utilized. Secondly, the collar 20 provides the ability to attach the fastener directly to a supporting structure, such as a supporting joist or cross-beam. This connection is made through the bore 36 that is located in the center of the collar 20. A coated or stainless steel screw may be inserted into the bore 36 and then the screw driven into the underlying joist or support structure (not shown). Other types of screws, nails, or fasteners may also be utilized for attaching the fastener to a support structure.

Depressions 42 may be disposed on the side of the shaft 16 along the length thereof. Multiple depressions 42 may be utilized, such as shown in FIGS. 1 and 3. The depressions 42 are used to save material during the molding process and to provide additional flared portions 44 that assist in creating a frictional connection with an aperture 22. The flared portions 44 are shown best in FIG. 3.

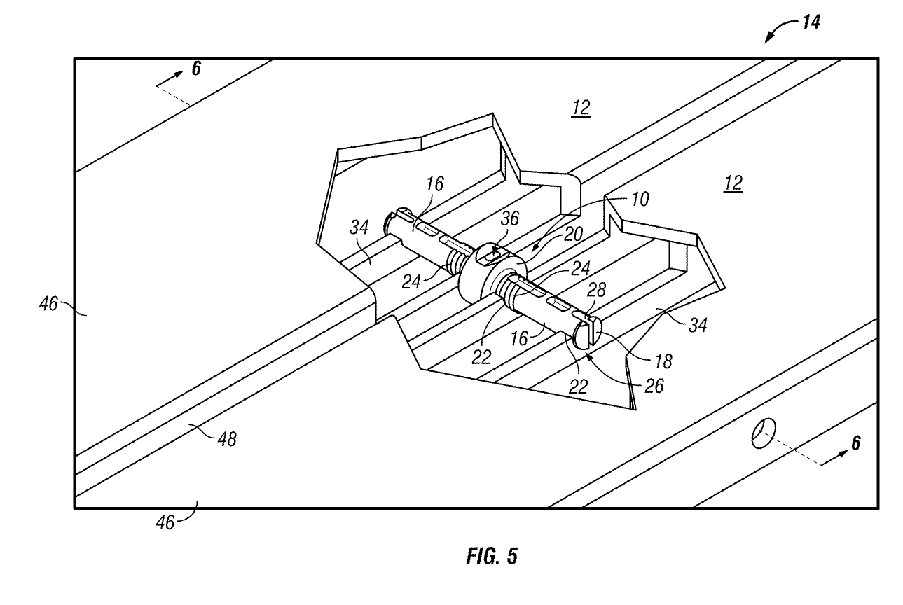

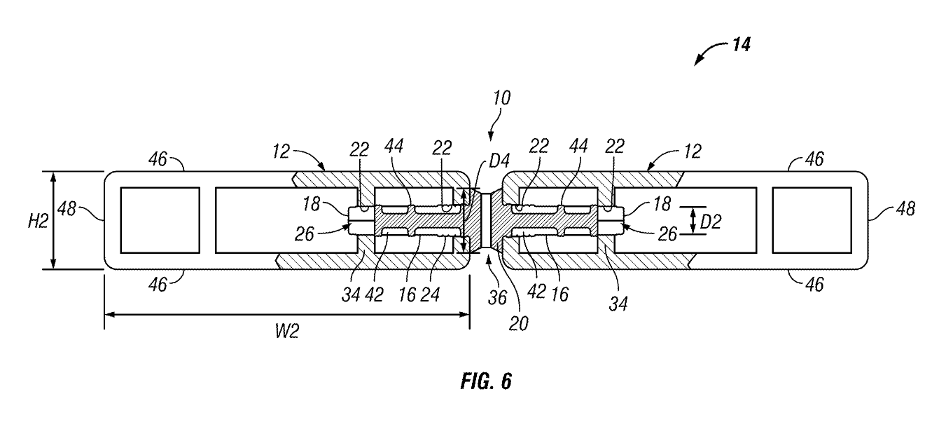

Referring to FIGS. 5 and 6, an example connecting system 14 is depicted that utilizes the example fastener 10 of FIGS. 1-4 in connection with two side-by-side, hollow-core composite boards 12. The hollow-core composite boards 12 have opposing exterior faces 46 and exterior side walls 48. The hollow-core composite boards 12 also include an internal rib 34. As shown in FIG. 6, each board 12 has two internal ribs 34 that are equally spaced from the side walls 48 thereof.

Apertures 22 are defined on opposing side walls 48 of the boards 12 for accepting the ends 18 of the example fastener 10. The fastener 10 shown in FIG. 5 includes two flared tabs 26 at either end 18 of the shaft 16. These tabs 26 are inserted through an aperture in the internal rib 34 of the boards 12 and the lip 32 of the tab 26 snaps into place behind the internal rib 34.

The fastener 10 is shown inserted into apertures 22 that are disposed on the side walls 48 of the boards. Alternatively, apertures could be defined on the face or ends of the boards to provide a different structure. The central collar portion 20 provides a fixed spacing between the side walls 48 of the boards 12 and is recessed relative to the faces 46 of the boards 12.

The example connecting system 14 may be utilized to create pre-assembled panels that consist of multiple boards 12 that are joined by the fasteners 10. One proposed use for the pre-assembled panels is for docks. Use of the fasteners 10 in connection with decking installation resulted in a 60% or greater reduction in installation time. In some instances, it resulted in a 75% or greater reduction in installation time.

FIGS. 7-11 depict another example fastener 110. Fastener 110 is similar to fastener 10 in many respects. In this example, the fastener 110 has a rectangular central collar portion 120 that has a height H1 and a width W1. The height H1 of the central collar portion 120 is greater than a diameter D1 of the shaft 116. As with the prior example fastener 110, the fastener 110 shown in FIGS. 7-11 includes a substantially cylindrical shaft 116 having two opposed ends 118. The central collar portion 120 is positioned between the two ends 118. As shown, the portions of the shaft 116 on either side of the central collar portion 120 are substantially the same length, but could be different lengths. The shaft 116 has a diameter D1 that is dimensioned to fit snugly inside an aperture 22 such that force must be applied to insert the shaft 120 into an aperture 22.

A plurality of outwardly extending cylindrical ridges 124 are positioned adjacent the central collar portion 120 on either side thereof. The ridges 124 extend along part of the length of the shaft 116. The raised ridges 124 have a diameter D3 that is greater than the diameter D1 of the shaft 116. The ridges 124 provide a frictional locking action against the interior of an aperture 22 for assisting in holding the fastener 110 inside an aperture 22. The opposed ends 118 of the shaft 116 may be co-linear, as shown.

The ends 118 of the shaft 116 include outwardly flared portions 126, such as outwardly extending tabs. The outwardly flared portions 126 provide a spring-like action for holding the shaft 116 in an aperture 22. A slot 128 may be cut into each end of the shaft 116 in the vicinity of the tabs 126 in order to allow the tabs 126 to flex inwardly when inserted into an aperture 22. The slot 128 is shown best in FIG. 8. The outwardly flared portions 126 provide a spring-like action against the interior of an aperture 22 once installed. This spring-like action provides locking power for locking the shaft 116 inside an aperture 22. The tab preferably has a lip 132, which may be utilized in some examples for snapping behind an internal rib 34 defined inside a hollow-core board 12. Other mechanisms for flaring the ends outwardly to create a spring action may also be utilized with equal success.

The central collar portion 120 has a centrally disposed bore 136 that extends therethrough. The bore 136 may be a cylindrical hole, a tapered hole, or a combination of cylindrical and tapered. A cylindrical bore 138 is shown in FIG. 9 that has a tapered opening 140. The bore 138 is sized for accepting a second fastener, such as a screw or a nail (not shown).

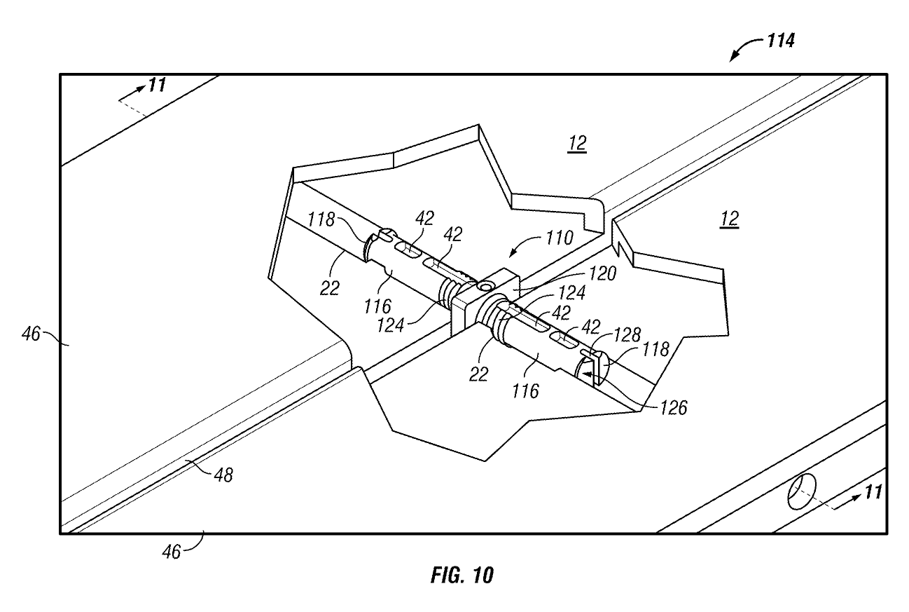

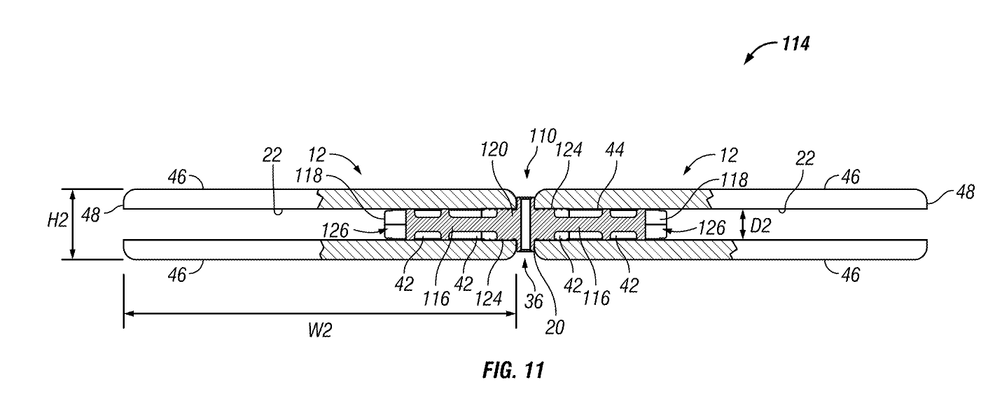

FIGS. 10 and 11 depict the example fastener 110 installed in a solid core board 12. The aperture 22 is shown in this example extending all the way through the width W2 of the board 12. Alternatively, the apertures 22 may extend only partially through the board 12. Since the boards 12 shown do not have an internal rib 34, the tabs 126 and ridges 124 on the shaft 116 of the fastener 110 press against the internal sides of the aperture 22 to create a frictional connection therewith. This helps to deter removal of the fastener 110 from the apertures 22 such that force must be utilized to remove the fastener 110 from the aperture 22 (such as a pry bar). The central collar portion 120 shown has a rectangular shape, with a height H1 that is greater than the diameter of the shaft D1, but less than the height H2 of the boards 12 such that the central collar portion 120 is recessed relative to the faces 46 of the boards 12.

The fastener 10, 110 may be utilized in the following manner. In order to install the fastener 10, 110 to couple boards 12 together, opposing holes or apertures 22 are defined in the side walls 48 of the boards 12. These holes 22 are preferably pre-formed but could alternatively be drilled at the construction site. The drill diameter may vary based upon the diameter D1 of the shaft 16, 116 of the fastener 10, 110. The holes 22 may have a diameter D2 that is equal to or less than the diameter D1 of the shaft 16, 116 in order to provide a press-fit into the apertures 22.

With decking installations, joists are typically 16 or 24 inches on center. Thus, the holes 22 are drilled along the lengths of the boards 12 to match up with the spacing of the underlying support structure. Hole locations can be drilled to accommodate the spacing of existing framing, even if it's not a standard spacing.

Once the holes 22 are drilled, one end 18, 118 of a fastener 10, 110 is inserted into each hole 22 in a board 12. The fastener 10, 110 is then driven into place. Then an adjacent board 12 is aligned with and installed on the other end 18, 118 of the fasteners 10, 110 in order to couple two boards 12 together. A mallet may be utilized to pound the side wall 48 of the board 12 onto the other end 18, 118 of the fasteners 10, 110. Once inserted, the fasteners 10, 110 cannot typically be removed without the use of a tool, such as a pry bar.

Once the boards 12 are connected together, the connection is complete and additional boards 12 may be added to the free sides of the boards 12. The process may be repeated until multiple boards are coupled together to form a panel of boards. The system can be used to form panels for later installation or to join individual boards at the construction site.

Once the boards 12 or panels are placed over a support structure, such as a joist, a fastener, such as a screw, may be inserted into the bore 36, 136 in the central collar portion 20, 120 of the fastener 10, 110 and screwed to the joist below. This process is repeated until all of the fasteners 10, 110 are attached to the underlying support structure.

When hollow-core boards are utilized, an internal rib 34 may be spaced from the side walls 48 a distance that is substantially equal to the length L1 of each portion of the shaft 16, 116 minus the length L2 of the tabs 26, 126. When the fastener shaft 16, 116 is inserted into the aperture 22 in the side wall 48, the tabs 26, 126 enter the aperture in the internal rib 34 and snap behind the internal rib 34. This helps to secure the fastener 10, 110 in place inside the hollow-core board. The fastener 10, 110 can then only be removed with a tool, such as a pry bar.

The fastener 10, 110 can be constructed from plastic, aluminum, stainless, steel, brass, fiberglass, or other known materials. The fastener 10, 110 may be formed by molding or other manufacturing techniques. The term “substantially,” as used herein, is a term of estimation.

While the principles of the invention have been described above in connection with preferred embodiments, it is to be clearly understood that this description is made only by way of example and not as a limitation of the scope of the invention.

1. A fastener for fixedly connecting two members in spaced relation to one another comprising:
a substantially cylindrical shaft having two opposed ends and a central collar portion positioned between the two opposed ends, with at least one outwardly extending cylindrical ridge positioned adjacent the central collar portion on either side thereof, wherein the shafts are configured to be inserted longitudinally into apertures defined in the members and the at least one ridge is configured to assist in retaining the respective shaft in a respective aperture.

2. The fastener of claim 1, wherein the two opposed ends of the shaft are co-linear and flare outwardly to provide a spring-like action when installed in an aperture.

3. The fastener of claim 1, further comprising at least one depressible tab positioned at each end of the shaft for assisting in holding the fastener in an aperture.

4. The fastener of claim 3, further comprising a longitudinally extending slot defined at each end of the shaft in the vicinity of the depressible tabs for allowing the depressible tabs to spring inwardly when inserted into an aperture.

5. The fastener of claim 1, wherein the central collar portion has a bore extending therethrough for accepting a second fastener for fixing the shaft to a support member.

6. The fastener of claim 1, wherein the central collar portion has a height and a width, with the height being greater than a diameter of the shaft such that the central collar portion serves as a spacer for spacing the two members by the width of the central collar portion.

7. The fastener of claim 1, further comprising at least one depression disposed in the shaft on either side of the central collar portion.

8. The fastener of claim 1, wherein the fastener is formed from a plastic material.

9. The fastener of claim 1, wherein the central collar portion is cylindrical and has a diameter that is greater than a diameter of the shaft.

10. A connecting system comprising:
at least two elongated members having opposing apertures; and
at least one fastener positioned between the at least two elongated members for fixedly coupling the elongated members together in spaced relation via the opposing apertures, with the fastener having a substantially cylindrical shaft with two opposed ends and a central collar portion positioned between the two opposed ends, with at least one outwardly extending cylindrical ridge positioned adjacent the central collar portion on either side thereof, wherein the at least one ridge assists in retaining the respective shaft in the respective aperture.

11. The connecting system of claim 10, wherein the ends of the fastener further comprise outwardly flared tabs for assisting in retaining the shaft in the aperture.

12. The connecting system of claim 10, wherein the central collar portion has a height that is less than a height of the elongated members.

13. The connecting system of claim 10, wherein the elongated members are boards.

14. The connecting system of claim 13, wherein the boards are composite boards.

15. The connecting system of claim 14, wherein the composite boards are one of hollow-core or solid-core boards.

16. The connecting system of claim 11, wherein the elongated members are composite boards having a hollow-core, with the boards having at least one internal ridge that is engaged by the tabs in order to lock the fastener in place against the at least one internal ridge.

17. A method of fixedly connecting two or more elongated members together comprising:
providing a first elongated member and a second elongated member, with each elongated member having an aperture disposed in opposing sides thereof;
inserting one end of a fastener into the aperture in the first elongated member, the fastener having a substantially cylindrical shaft with two opposed ends and a central collar portion positioned between the two opposing ends, with at least one outwardly extending, cylindrical ridge positioned adjacent the central collar portion on either side thereof, wherein when the shafts are inserted longitudinally into the opposed aperture, the ridges assist in retaining the respective shaft in the respective aperture;
driving the fastener into the aperture until the central collar portion abuts the side of the first elongated member;
inserting the other end of the fastener into the aperture disposed in the side of the second elongated member; and
driving the other end of the fastener into the second elongated member until the central collar portion abuts the side of the second elongated member.

18. The method of claim 17, wherein the central collar portion of the fastener has a bore extending therethrough and further comprising inserting a second fastener into the bore for coupling the fastener and elongated members to an underlying support member.

19. The method of claim 17, wherein the first and second elongated members comprise a plurality of solid boards and the at least one fastener comprises a plurality of fasteners, with the apertures being defined by drilling holes into the sides of the boards at spaced locations, the method further comprising inserting a fastener into each aperture, with each end of the respective fastener being inserted into adjacent boards in order to form a panel of boards fixedly connected to one another.

20. The method of claim 17, wherein the first and second elongated members comprise hollow-core, composite boards and the at least one fastener includes at least one depressible tab positioned at each end thereof, and each of the boards has an internal ridge for mating with the depressible tab of the fastener, with the method further comprising inserting the end of the fastener into the aperture until the depressible tab snaps behind the internal ridge to fixedly couple the fastener to the board and to fixedly couple the first elongated member to the second elongated member with the fastener.
